(19) United States
(12) Patent Application Publication
(10) Pub. No.: US 2014/0214443 A1
(43) Pub. Date: Jul. 31, 2014

(54) Systems and Methods for Displaying Metrics Associated With a Health Improvement Program

(71) Applicants: Sean Patrick Duffy, San Francisco, CA (US); Andrew Paul DiMichele, San Francisco, CA (US); Adrian Benton James, Oakland, CA (US)

(72) Inventors: Sean Patrick Duffy, San Francisco, CA (US); Andrew Paul DiMichele, San Francisco, CA (US); Adrian Benton James, Oakland, CA (US)

(21) Appl. No.: 14/190,017

(22) Filed: Feb. 25, 2014

Related U.S. Application Data
(63) Continuation-in-part of application No. 13/668,644, filed on Nov. 5, 2012.
(60) Provisional application No. 61/555,455, filed on Nov. 3, 2011.

(51) Int. Cl. G06F 19/00

(52) U.S. Cl. CPC G06F 19/3475; G06F 19/3481
USPC 705/2

(57) ABSTRACT

System and methods for tracking participants in a health improvement program are provided herein. A method includes tracking performance of participants in a group program, the group program having an overall program time frame, the group program having one or more sub-programs that when executed by the participants in the participant group aid the participants in achieving the common heath goal, each of the sub-programs comprising a task to be completed by the participant; and generating, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program.

### CROSS REFERENCE TO RELATED APPLICATIONS

This application is a continuation-in-part of U.S. Non-Provisional application Ser. No. 13/668,644, titled “METHOD AND SYSTEM FOR SUPPORTING A HEALTH REGIMEN”, filed on Nov. 5, 2012, which claims the benefit of U.S. Provisional Application No. 61/555,455, titled “Method and User Interface for Supporting a Health Regimen” filed on Nov. 3, 2011, all of which are hereby incorporated by reference herein in their entireties including all references cited therein.

### FIELD OF THE INVENTION

The present technology is generally directed to health improvement technologies, and more specifically, but not by way of limitation, to systems and methods for improving the health of participants in a group program in such a way that a maximum number of participants complete the group program and achieve a common health goal. These systems and methods include a synchronous start time for the participants in the group program, as well as performance tracking of individual sub-program completion by participants.

### BACKGROUND

It is well known that people with excess body weight (e.g. body fat) have increased risk of health problems, such as diabetes and cardiovascular disease. Medical professionals generally advise overweight or obese patients to lower their risk of health complications by losing excess weight. For example, people with pre-diabetes (a condition in which glucose levels are higher than normal but are not high enough for a diagnosis of diabetes) can delay or lower their risk of developing diabetes by losing a modest amount of weight through dietary changes and increased physical activity. However, despite general guidelines such as improved diet or increased exercise, it may be difficult for many to effectively lose weight. Generic guidelines may not be suitable or useful for certain individuals, and many may not have access to personal nutritionists or trainers. Drastic lifestyle changes are often difficult to implement, and may contribute to lost motivation that hampers effective weight loss. Thus, there is a need in the medical field to create an improved method and user interface for supporting a health regimen. This invention provides such an improved method, system, and user interface.

### SUMMARY

According to some embodiments, the present technology is directed to a method for displaying metrics of participants in a group program tailored to achieving a common health goal using a health program tracking system comprising a processor and logic, the logic being executed by the processor to perform the method, comprising: (a) tracking performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and (b) generating, for each participant in the group program, a first visual display that represents a current completion percentage for at least one of a sub-program, and a second visual display that represents a current completion percentage of the group program or a task of a sub-program.

According to some embodiments, the present technology is directed to a system for improving the health of participants in a group program in such a way that a maximum number of participants complete the group program and achieve a common health goal. The system comprises: (a) a processor; and (b) a memory for storing executable instructions that are executed by the processor to: (i) track performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and (ii) generate, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program.

According to some embodiments, the present technology may be directed to a method for displaying metrics of participants in a group program tailored to achieving a common health goal using a health program tracking system that executes a method comprising: (a) tracking performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and (b) generating, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program, wherein the first visual display includes a circular bar that encircles a photograph of a participant, and the circular bar encircles the photograph in accordance with the completion percentage, further wherein the second visual display comprises linear arrangement of dots representing previously completed tasks of the at least one sub-group, the dots being filled after completion of the tasks associated therewith.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIGS. 1 and 2 are schematics of an embodiment of a method for supporting a health regimen of a preferred embodiment;

FIG. 3 is a schematic of an example of filtering measurement data in the method of a preferred embodiment;

FIGS. 4A and 4B are examples of determining trends of the body metric measurements of a participant and of a matched group;

FIG. 5A depicts an embodiment of a user interface for supporting a health regimen;

FIG. 5B is an example of a home page in an example embodiment of a user interface for supporting a health regimen;

FIG. 6 is an example of a profile page in an example embodiment of a user interface for supporting a health regimen;

FIG. 7 is an example of a progress page in an example embodiment of a user interface for supporting a health regimen;

FIG. 8 is an example group page in an example embodiment of a user interface for supporting a health regimen;

FIGS. 9A and 9B are example communications between participants in an example embodiment of a user interface comprising a message client;

FIG. 10 is an example curriculum page in an example embodiment of a user interface for supporting a health regimen;

FIG. 11 is an example communication between a facilitator and a participant in an example embodiment of a user interface for supporting a health regimen;

FIG. 12 is a second example of a profile page in a second example embodiment of a user interface for supporting a health regimen;

FIG. 13 is a second example of a group page in a second example embodiment of a user interface for supporting a health regimen;

FIG. 14 is a second example of a curriculum page in a second example embodiment of a user interface for supporting a health regimen;

FIG. 15 is a sample health regimen curriculum scheme based on a diabetes prevention program;

FIG. 16 depicts an embodiment of a system for supporting a health regimen;

FIG. 17 is schematic diagram of an exemplary architecture that includes a health program tracking system for practicing aspects of the present technology;

FIG. 18 is a flowchart of an exemplary method for displaying metrics of participants in a group program tailored to achieving a common health goal using a health program tracking system;

FIG. 19 is a flowchart of an exemplary method for displaying performance related metrics to a coach or third party;

FIG. 20 is a GUI that includes a first visual display for a first participant that is indicative of the current completion percentage for the task of a sub-program;

FIG. 21 is a GUI that illustrates visual indicators that illustrate when a participant has successfully completed a task; and

FIG. 22 illustrates an exemplary computing system that may be used to implement embodiments according to the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

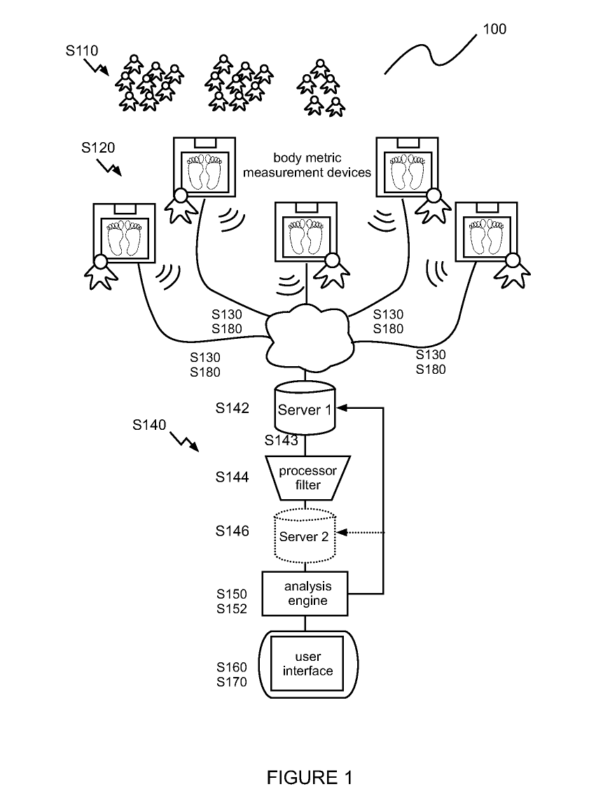

As shown in FIG. 1, in a preferred embodiment, the method 100 for supporting a health regimen includes the steps of: grouping a plurality of participants into a matched group S110; providing, to each participant of the matched group, a body metric measurement device configured to communicate remotely with a network S120; receiving a set of body metric measurement data S130 over the network from a participant and a portion of the participants of the matched group S130; storing the set of body metric measurement data S140 on a server; determining a body metric measurement trend of the participant S150; determining a body metric measurement trend of the portion of the matched group S152; and providing feedback to the participant S160 based on the body metric measurement trend of the participant relative to the body metric measurement trend of the portion of the matched group S160. The method 100 may further include providing, to each participant of the matched group, a health regimen curriculum S170, and providing a physical motivational incentive to the participant S180. A facilitator leading the matched group and/or the participants in the matched group may provide feedback and support tailored to the matched group overall and/or to individual participants in the matched group. At least some of the steps are preferably repeated through the health regimen. In particular, receiving a set of body metric measurement data S130, storing the set of body metric measurement data S140, determining a trend in the body metric measurements of the participant S150, determining a trend of in the body metric measurements of the matched group S152, and providing feedback to the participant S160 are preferably repeated cyclically, and some of these steps may be repeated multiple times within a cycle.

The method 100 is preferably used to facilitate a social environment in which the participants interact with the facilitator and/or one another to more effectively follow a health regimen. In one preferred embodiment, the method 100 is used to help guide participants diagnosed with prediabetes to lose weight to reduce their risk of developing diabetes. In particular, the method may be used to guide participants through the steps outlined in the Diabetes Prevention Program (a research study funded by the National Institute of Diabetes and Digestive and Kidney Diseases). The National Diabetes Prevention Program core curriculum, core session handouts, post-core curriculum, post-core session handouts, and additional materials (National Center for Chronic Disease Prevention and Health Promotion, Diabetes Training and Technical Assistance Center at the Rollins School of Public Health, Emory University) are incorporated herein by reference. In another embodiment, the method 100 is used to help guide participants diagnosed with obesity to lose weight through an exercise and/or diet regimen. Furthermore, in alternative embodiments the method 100 may be used to support health regimens regarding other body metrics, such as BMI, body fat percentage, blood pressure, cholesterol, or other suitable measurements. In variations of the embodiments, the method 100 may be used in a group, support-oriented setting to monitor weight loss or gain in other applications, such as to monitor rapid weight gain indicative of swelling after a diagnosis of congestive heart failure, to monitor unintended weight loss suggestive of paraneoplastic syndrome after a diagnosis of cancer (e.g., prostate or lung cancer), to monitor weight fluctuations after diagnosis of hyper- or hypothyroidism or hyper- or hypoadrenalism (which may indicate, for example, medication dosing errors or changes in the endocrine defect), or to monitor weight trends after diagnosis of eating disorders such as anorexia. In some alternative variations of the embodiments, the method 100 may omit grouping the participants into at least one matched group, such that trends and feedback are determined on an individual basis only.

Grouping a plurality of participants into a matched group S110 functions to establish a community among participants. The participants within a matched group preferably share at least one common goal related to a body metric measurement, such as losing weight, maintaining weight, gaining weight, or reducing body fat percentage, and/or a common goal related to a health condition, such as preventing development of prediabetes to diabetes. Alternatively the participants within a matched group are grouped based on another characteristic. In a preferred embodiment, a matched group includes approximately 8-16 participants, although the matched group may include any suitable number. Grouping a plurality of participants may include one or more variations that cluster participants in similar or the same groups based on various shared characteristics.

In a first variation, grouping a plurality of participants into a matched group S110 includes grouping participants based on a characteristic of a common goal. In a first example of the first variation, the participants within a matched group may share the goal of losing or gaining a certain percentage (e.g. 5%) of an individual respective starting weight or a certain number of pounds. In a second example of the first variation, the participants within a matched group may share the goal of maintaining current starting weight or to attain a particular goal weight. In other examples of the first variation, the participants within a matched group may share the goal of losing, gaining, maintaining, or attaining a particular level or amount of BMI, body fat percentage, or other body metric measurement.

In a second variation, grouping a plurality of participants into a matched group S110 includes grouping participants based on medical history. In a first example of the second variation, participants within a matched group may be diagnosed with a particular condition at approximately the same time (e.g. diagnosed with pre-diabetes within two months of one another, or another suitable threshold). In a second example of the second variation, participants within a matched group may have similar initial body weights, similar initial degree (class or stage) of congestive heart failure or other diagnosis of a cardiovascular disease. In a third example of the second variation, participants within a matched group may be diagnosed with a similar degree of obesity, and in a fourth example of the second variation, participants within a matched group may be diagnosed with a similar stage of osteoarthritis or other joint disease that affects mobility. Other aspects of medical history may be considered in matching participants, such as diagnosis of depression or obsessive-compulsive disorder.

In a third variation, grouping a plurality of participants into a matched group S110 includes grouping participants based on shared personality traits, or similar positions within a personality spectrum. In an example of the third variation, participants within a matched group may have received similar results of a personality test or other assessment. Shared personality traits may include, for instance, optimism, extroversion, openness, agreeableness, or neuroticism. Grouping participants into a matched group may include administering to the participants a standard personality test (e.g. Myers-Brigg personality test, Big Five personality test) or a customized personality test, and clustering participants into matched groups based on the results of the standard or customized personality test.

In a fourth variation, grouping a plurality of participants into a matched group S110 includes grouping participants based on a shared lifestyle characteristic or common interests. In an example of the fourth variation, participants within a matched group may have similar dietary restrictions or preferences (e.g., vegetarianism, veganism, nut-free, gluten-free), marriage status (e.g., married, divorced, widowed, single), children status (e.g. existence, age, gender, number of children), pet status (e.g. existence, age, species, number of pets), religious identification, or other suitable lifestyle characteristic. In another example of the fourth variation, the participants within a matched group may have similar hobbies or other interests (e.g. sports, television shows, cooking).

In a fifth variation, grouping participants into a matched group includes grouping participants based on personal information. In examples of the fifth variation, such personal information may include gender, ethnicity or nationality, age, current geographical area, or occupational field. As another example of the fifth variation, personal information may include hometowns, schools attended, employers, or any suitable personal information.

In additional variations, the step of grouping participants may incorporate any suitable combination of these variations and/or any suitable aspect of the participants. In some embodiments of the method, the participants may additionally and/or alternatively be grouped based on contrasting or complementary aspects, rather than all common traits. For example, participants within a matched group may include both optimists and pessimists, or extroverts and introverts. Furthermore, the step of grouping participants may include weighting one or more of the various characteristics more heavily than others in their importance in the grouping process. For example, grouping participants based on a characteristic of a common goal is preferably weighted more heavily than grouping participants based on personal information.

Grouping a plurality of participants into a matched group S110 may further include sorting the participants using a “tiered” or “staged” process that effectively places the various characteristics in a hierarchy of importance. For instance, in a first stage an initial group of participants may filtered into a second group of participants that exclusively share the goal of losing a particular percentage of their initial respective weights. In a second stage, the second group of participants may be further filtered into a third group of participants that are within a particular age range. In a third stage, the third group of participants may be further filtered into a fourth group of participants that are of the same gender. In this manner, the grouping process may include any suitable number of stages that successively reduce or sort a larger group of participants into smaller matched groups until one or more suitable matched groups are created. In another embodiment, grouping may additionally and/or alternatively include assigning each of the participants a classification or number based on the sorting characteristics and grouping the participants based on their respective classification or number. However, the sorting characteristics may be used to group participants into appropriate matched groups in any suitable manner.

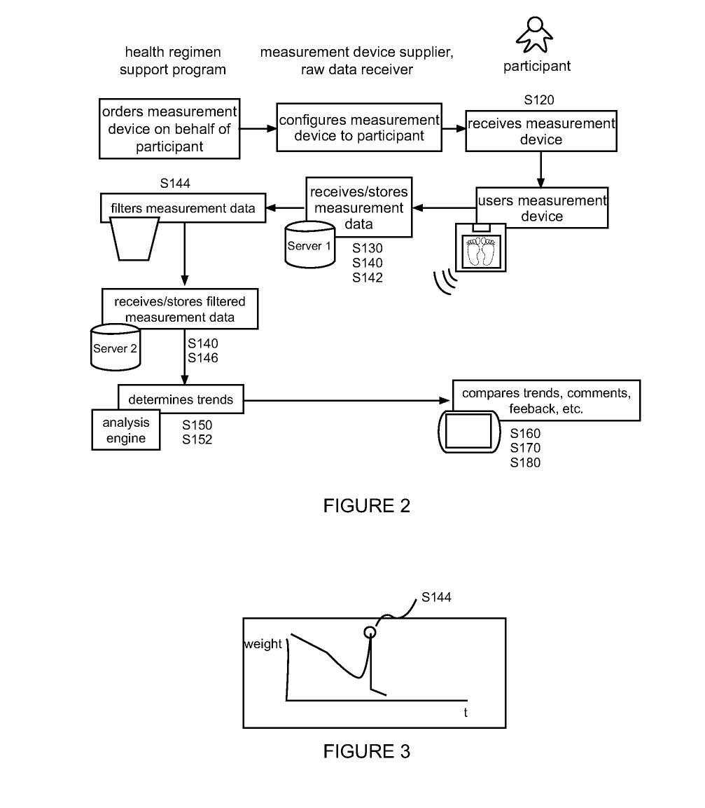

Providing, to each participant of the matched group, a body metric measurement device configured to communicate remotely with a network S120, functions to facilitate measuring a body metric of the participant and to facilitate a manner in which the participants can submit or communicate their body metric measurements (also referred to more simply as “measurements”, “measurement data”, or data points) to a server. Preferably, the body metric measurement device is a weight scale that measures the body weight of a participant. For example, the body metric measurement device may be a BodyTrace™ eScale. In alternative embodiments, the body metric measurement device may be a body fat measuring device (e.g. skinfold caliper), a sphygmomanometer that measures blood pressure, a blood glucose monitor, or any suitable body metric measuring device. Furthermore, the method 100 may further include providing multiple body metric measurement devices (e.g., a weight scale that communicates weight of the participant and a pedometer that communicates number of steps walked by the participant) to each participant of the matched group. Preferably, the body metric measurement device requires no user setup (e.g. calibration and setup performed before the user receives the device, as shown in FIG. 2), but alternatively, minimal setup by the user may be required (e.g. input of identification information prior to device activation). In some embodiments, as shown in FIG. 2, the body metric measurement device may be electronically paired or assigned to a particular participant, such as by linking a product serial number with the name of the participant and storing the link information in a database. The body metric measurement device is preferably configured to communicate over a network such that body metric measurement data may be uploaded to a remote storage, such as through cellular networks (e.g., Global System for Mobile Communications) or over the internet (e.g., Wi-Fi). As shown in FIG. 2, the body metric measurement device is preferably shipped directly to the participant or provided through a retailer, electronic ordering system, or other source to the participant. Preferably, identical models of a body metric measurement device are provided to all participants within a matched group, to maintain consistency and comparability of measurements between participants. Providing identical models of the body metric measurement device may further comprise calibrating all models provided to participants of a matched group, such that they perform consistently in relation to each other. In an alternative embodiment, the step of providing a body metric measurement device may be omitted; for example, instead of a distributor shipping the measurement device to the participants, the participants may be expected to purchase a measurement device on their own at a retailer or other source.

Receiving a set of body metric measurement data S130 over the network from the participant and a portion of the participants of the matched group functions to gather data from which to generate feedback in support of the health regimen. This step is preferably repeated over time such that a time series of body metric measurement data may be received in regular intervals (e.g., hourly, daily, weekly, biweekly) or irregular intervals from the participant and at least one other participant of the matched group. The set of body metric measurement data may further comprise multiple time series of body metric measurement data, the multiple time series of body metric measurement data comprising a time series from the participant, and a time series from each participant of the portion of the matched group. Measurements from the participant and from each participant of the portion of the matched group may be received at the same time or at different times; preferably, measurements from the participant and from each participant in the portion of the matched group are received at the same frequency and/or simultaneously. Alternatively, measurements from the participant and from each participant in the portion of the matched group are received at different frequencies and/or different instances. As described above, the multiple time series are preferably received over a network such as a Global System for Mobile Communication or Wi-Fi. Each body metric measurement in the set of body metric measurement data is preferably labeled with identifying information, such as date, time, and/or location of measurement, personal information identifying the participant being measured, and/or a serial number or other identifier of the body metric measurement device. A time series of measurements is preferably received with push technology, such that the measurement device of a participant initiates transmission of body metric measurement data. However, the time series of measurements may additionally and/or alternatively be received with pull technology, such that the receiver initiates transmission of the body metric measurement (e.g. through polling or manual initiation on the receiver side). A time series of body metric measurements may be received as individual measurements, or as packets or bundles of multiple measurements.

Storing the set of body metric measurement data S140 on a server or other database functions to create and maintain a record of received measurement data from the participant and one or more of the participants of the matched group. Storing the set of body metric measurement data S140 enables the set of body metric measurements, comprising at least one time series of data, to be shared. As shown in FIGS. 1 and 2, storing the set of body metric measurement data preferably includes storing the set of body metric measurement data on a first server S142, receiving the set of data from the first server S143, filtering the received set of data S144, and storing the filtered set of data on a second server S146 for later processing. The first server is preferably a server associated with the storing the raw body metric measurement data directly from the measurement device, as well as identifying information associated with the measurements. In an example embodiment of the method 100 using the BodyTrace™ eScale, the first server is a server dedicated to the BodyTrace™ network. A second server in the example embodiment receives body metric measurements from the first server in a manner similar to that of receiving body metric measurements from the body metric measurement devices (e.g., push or pull technology). Alternative embodiments of the method 100 may comprise storing the set of body metric measurement data on multiple servers, with additional filtering and/or receiving steps.

Storing the set of body metric measurement data S140 on a server preferably comprises filtering the received set of body metric measurement data S144, which functions to remove any suspicious measurements from the received measurement data. In particular, filtering preferably includes identifying erroneous measurements. Example erroneous measurements include measurements that are unlikely to come from a participant (e.g. measurements resulting from outsider interference), erroneous measurements due to device malfunction, erroneous measurements due to participant error, and other non-representative measurements. In one embodiment, the method 100 may further comprise detecting if an outsider has used the device (e.g. through identity verification), so as to produce an erroneous measurement. As shown in FIG. 3, identifying erroneous measurements may include analyzing for unrealistic measurement gains or losses (outliers) compared to previously determined body metric measurement trends. In a first example of filtering the received set of body metric measurement data S144, a single body metric measurement may be identified/flagged if the measurement indicates a significant weight gain of 10 pounds over one day relative to the average weight of the previous 5 days. In a second example of filtering the received set of body metric measurement data S144, any body metric measurement in the received set of body metric measurement data may be identified/flagged if the measurement deviates from an adjacent measurement by a specified amount. In a third example of filtering the received set of body metric measurement data, a line may be fitted to the set of body metric measurement data, and any measurement that has a residual (relative to the line) with an absolute value greater than a specified amount may be identified/flagged. However, any suitable analysis for filtering the received measurements may be performed. The identified/flagged measurements may be automatically removed from the data set or marked for manual review and removal from the data set. In some variations, the degree to which a flagged measurement is suspicious may affect whether the flagged measurement is automatically removed or marked for review (e.g., flagged measurements that deviate from the trend by a certain threshold amount are automatically removed from the data set).

Storing the filtered set of data on a second server S146 maintains a record of filtered measurements, such as for independent analysis (e.g. outside of the BodyTrace™ server in the example embodiment of the method 100 using the BodyTrace™ eScale). However, in an alternative embodiment, body metric measurement data may be stored in a single server, and filtering and other processing steps may be performed before or after storing the measurements on the server.

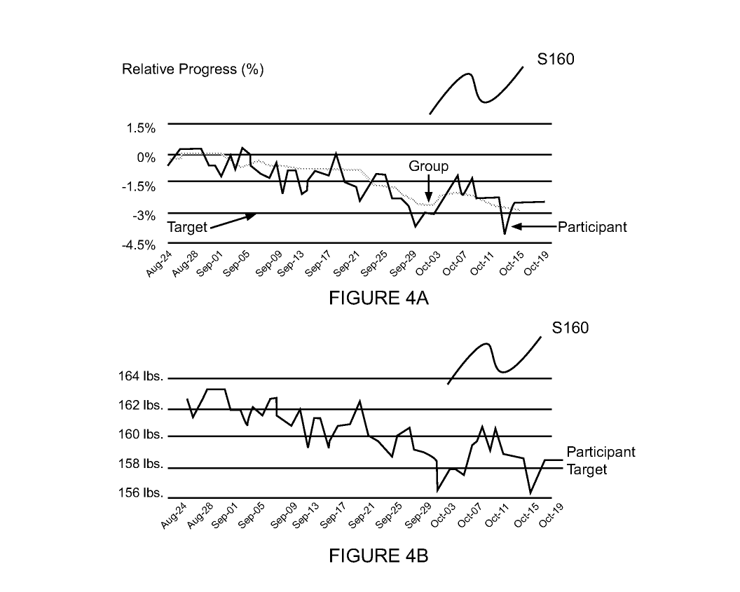

Determining a body metric measurement trend of the participant S150 functions to analyze the progress or status of the participant in the health regimen as a function of time. A determined trend is preferably subsequently stored on at least one of the servers for future use (e.g., filtering future received measurements), but alternatively, an additional server may be used to store a determined trend or a set of determined trends, each trend in the set of determined trends corresponding to a participant. Determining a body metric measurement trend of the participant S150 may include one or more of several variations: In a first variation, as shown in FIG. 4A, measurements used to determine the trend of the participant are analyzed and output as percentages relative to an initial baseline measurement. In an example of the first variation, following an initial baseline weight measurement of 200 pounds, a subsequent measurement of 195 pounds (loss of five pounds) is calculated as a data point of 2.5% loss relative to the initial baseline weight in a weight trend. Additional subsequent measurements based on the set of body metric measurement data are analyzed relative to the initial baseline weight measurement. In a second variation, as shown in FIG. 4B, measurements used to determine the trend of the participant are analyzed and output as absolute differences relative to an initial baseline measurement, similar to the first variation; however, in the second variation, measurements are expressed as absolute numbers rather than percentages. In a third variation, measurements used to determine the trend of the participant are determined as percentages relative to a previous measurement, or an averaged (e.g., mean or median) value of a certain number of previous measurements in a time series of body metric measurement data. In a fourth variation, measurements used to determine the trend of the participant are determined as absolute differences relative to one or more previous measurements, similar to the third variation; however, in the fourth variation, data points are expressed as absolute numbers rather than percentages. In a fifth variation, a line may be fitted to body metric measurements for the participant, and a rate of progress (e.g. weight loss per unit time) may be used to represent the trend of a participant.

Determining a body metric measurement trend of a portion of the matched group S152 functions to assess the progress or status of the matched group in the health regimen. Determining a trend of a portion of the matched group preferably comprises determining a trend based on a set of body metric measurement data representing all participants in the matched group or alternatively, less than all participants in the matched group. The determined trend is preferably subsequently stored on at least one of the servers for future use (e.g., filtering future received measurements), but alternatively, an additional server may be used to store a determined trend or a set of determined trends, each trend in the set of determined trends corresponding to a participant of the portion of the matched group. The trend for the portion of the matched group may be calculated in a manner similar to calculating the trend of a single participant using any suitable variation as described above, except that each measurement/data point for the portion of the matched group may be an averaged (e.g., mean or median) measurement value of all of the participants within the matched group. In a first example using averaged measurement values, a time series of body metric measurement data may be collected from each participant of the portion of the matched group, and measurements taken at similar time points (e.g. within a 24 hour period of time in a 16 week time period) may be averaged across all participants of the portion of the matched group for use in determining the trend of the matched group. In a second example using averaged measurement values, the trend of the matched group may include a different number of measurements than the number of measurements used to determine a trend in a body metric measurement of the participant S150, as measurements from the participants in the portion of the matched group may not be available for identical periods of time (e.g. measurements are received once per day from one participant and once every two days from another participant). In the second example, the trend of the matched group may include a set of measurements, each representing an average group value over a two-week period, while the trend of the participant may include a set of measurements, each measurement representing a daily value. However, both the trend of the participant and the trend of a portion of the matched group may have any suitable resolution of measurement data points. In a third example averaged measurement values, each corresponding to different time points for the portion of the matched group, may be fitted to a line, such that a rate of progress of the portion of the matched group (e.g. weight loss per unit time) may be used to represent the trend of the portion of the matched group. Preferably, the participant is a part of the portion of the matched group, such that the body metric measurement data of the participant is factored into determining the trend in the body metric measurement data of the portion of the matched group; however, alternatively, the trend in the body metric measurement of the portion of the matched group may be determined from a subset of the set of body metric measurement data, wherein the subset excludes the body metric measurement data of the participant.

Providing feedback to the participant S160 based on the trend in the body metric measurement of the participant relative to the trend in the body metric measurement of the portion of the matched group functions to use the trend in the body metric measurement of the portion of the matched group to support and motivate a participant during his or her health regimen. Preferably, the participant is a part of the matched group, such that the participant is motivated by fellow “team members” in the matched group to adhere to the health regimen. In a variation, the participant, as part of the matched group, “competes” against other matched groups as a source of support and motivation during his or her health regimen. Alternatively, the participant is not a part of the matched group, such that the participant “competes” against the matched group as a source of motivation during his or her health regimen. Preferably, feedback is provided through a user interface (described further below in more detail) communicatively coupled to at least one server that stores body metric measurements of the participants. The user interface is preferably an application accessed through a computing device, or alternatively, a website presented as a separate online social network site or online community. The user interface may alternatively be hosted by a third-party social network site. Providing feedback may include one or more of several steps as described below; however, the feedback may be provided in any suitable manner.

As shown in FIGS. 4A and 4B, providing feedback to the participant S160 preferably includes displaying the trend in the body metric measurements of the participant and/or displaying the trend in the body metric measurements of the matched group. One or both of these trends may be displayed on a profile page of the participant in a user interface. The trends are preferably displayed on charts as a function of time, with any suitable time divisions (e.g., daily, biweekly, weekly, monthly). The trends may additionally and/or alternatively be displayed as tables, bar graphs, or in any other format. In an embodiment, the method 100 follows a designated health regimen program such as the Diabetes Prevention Program, and providing feedback to the participant S160 further includes displaying individual and/or group progress in the health regimen program and metrics of any activities associated with the health regimen, such as walking (e.g. determined using a connected pedometer). Simultaneously displaying trends of a participant and of the matched group enables the participant to directly compare his or her progress and success in the health regimen with that of other participants, at least relative to the overall progress of the matched group. The overall progress of the matched group and individual progress of other participants in the matched group may be motivational to a particular participant, and are preferably relevant to a particular participant because of the nature in which the participants were sorted and grouped.

Providing feedback to the participant S160 preferably further includes enabling a facilitator associated with the matched group to access the trend of the participant and/or the trend of the portion of the matched group. Similarly, providing feedback to the participant S160 preferably further includes enabling one or more of the participants in the matched group to view a displayed trend of another participant and/or the trend of a portion of the matched group. However, providing feedback to the participant S160 may further include allowing the participant to designate privacy settings that limit the details available to other participants and/or the facilitator. For example, the participant may select settings such as to enable the facilitator and/or other participants to view a trend of his weight measurements represented in percentage of change, but to restrict the facilitator and/or other participants from viewing a trend of his/her weight measurements represented in absolute numbers.

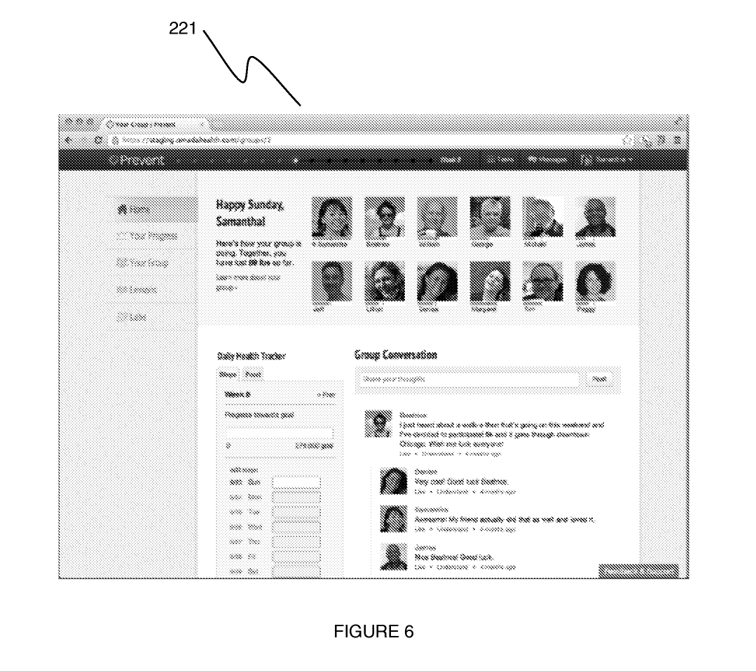

Providing feedback to the participant S160 preferably further includes enabling a facilitator associated with the matched group to provide comments to one or more of the participants in the matched group. As shown in FIG. 6, the facilitator may address general comments to the matched group on a group page of a user interface. The facilitator may additionally and/or alternatively provide targeted comments to a particular individual participant, such as by posting comments on the profile page of the participant, and/or by sending a personalized message accessible only by the individual participant and the facilitator. Similarly, providing feedback may further include enabling a participant in the matched group to provide comments to one or more of the other participants in the matched group, including general comments on the group page, targeted comments on the profile page of a particular targeted participant, and/or personalized messages accessible only by the participant and the targeted participant. Comments from the facilitator and fellow participants in the matched group serve to provide motivation and support throughout the health regimen. Such comments may include, for example, congratulatory remarks on a completed milestone, suggestions for modifications in activities (diet, exercise plan, etc.), general motivational remarks, sharing of personal stories to enhance personal connections within the matched group and/or facilitator, questions to generate discussions, invitations to perform a health regimen curriculum task socially, or any suitable comments. In some embodiments, providing feedback further includes enabling a facilitator and/or participants in the matched group to share photos or other media with another participant or the matched group in general.

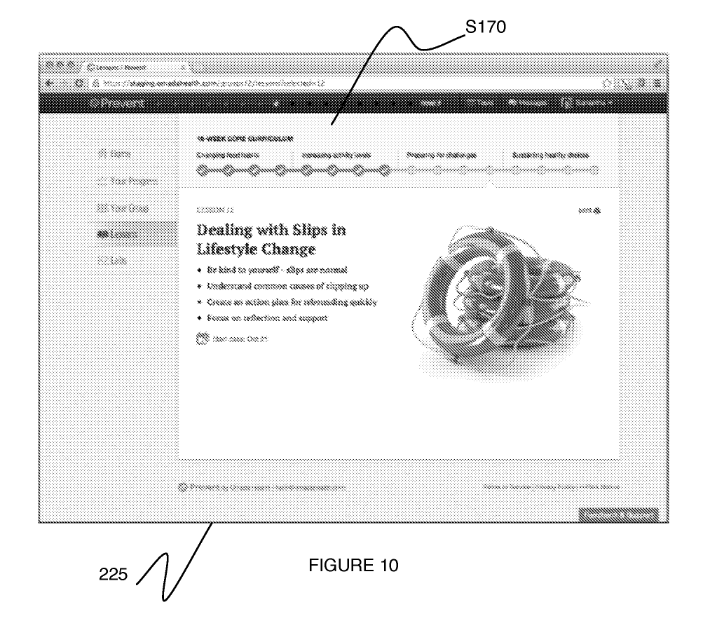

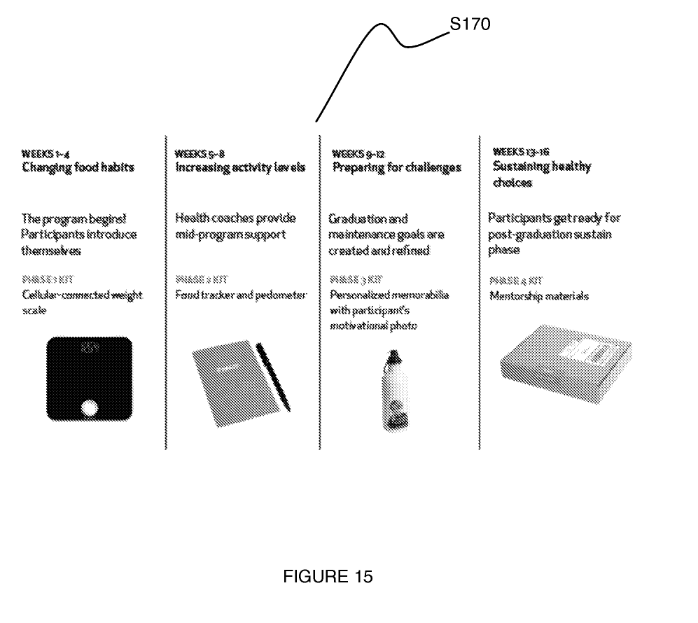

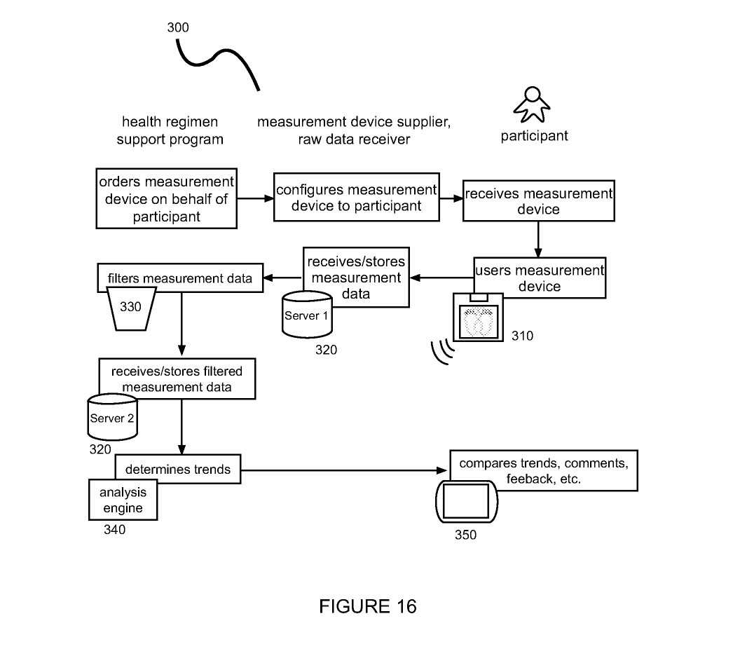

The method 100 may further include providing a health regimen curriculum S170 to each participant of the matched group, which functions to change a participant's eating and activity in order to achieve a goal. In a first example, the health regimen curriculum comprises steps outlined in the Diabetes Prevention Program (a research study funded by the National Institute of Diabetes and Digestive and Kidney Diseases), and providing a health regimen curriculum comprises presenting steps based on the Diabetes Prevention Program as lessons through a user interface. In the first example, as shown in FIGS. 10 and 15, the lessons may be organized into four phases, including: a first phase involving changing food habits, a second phase involving increasing activity levels, a third phase involving preparing for challenges, and a fourth phase involving sustaining healthy choices; furthermore, the participant may be encouraged to set goals and meet milestones, as well as complete assignments (e.g. journal entries, meal experiments) as part of the health regimen curriculum in the first example. The first example providing each of the four phases of lessons may be accompanied by providing a kit corresponding to each phase, wherein the first phase kit comprises a body metric measurement device (e.g. a network-connected weight measurement device), the second phase kit comprises a second measurement device and tool (e.g. a pedometer and a food tracking tool), the third phase kit comprises motivational prizes (i.e. upon graduating from the curriculum), and the fourth phase kit comprises materials to support the participant in sustaining healthy choices (i.e. post-graduation). In a second example, providing a health regimen curriculum S170 may comprise providing a diet modification and exercise routine regimen comprising daily meal plans and exercise tasks geared to treat a diagnosed condition, such as cardiovascular disease or diabetes. In a third example, providing a health regimen curriculum S170 may comprise providing a physical therapy regimen curriculum. In other examples, providing a health regimen curriculum S170 may comprise providing any appropriate health regimen curriculum for a given condition, that is preferably fixed, or alternatively, customizable by a participant, facilitator, or automatically to meet the participant's specific needs. The health regimen may be customizable by a facilitator or automatically, such that if the participant is not making progress at a rate comparable to that of a matched group, the health regimen may give the participant additional feedback and advice so that the participant is given an advantage or “handicap” relative to the matched group. The customized health regimen may be provided based on a performance metric of the participant, such as absolute change in body weight relative to an initial baseline measurement (after a period of time has elapsed from initiation of the regimen) or an unmet goal set by the participant and/or a facilitator.

The method 100 may further include providing a physical motivational incentive to the participant S180, which functions to promote adherence to the health regimen curriculum. Providing a physical motivational incentive to the participant S180 may comprise providing health-related physical awards, such as coupons, nutritional supplements, and/or exercise equipment. In an example, providing a physical motivational incentive to the participant S180 may be performed after the participant has reached a health regimen goal/milestone, or if the participant experiences a quantifiable level of progress above a specified threshold. In an alternative example, providing a physical motivational incentive to the participant S180 may be performed if the participant is not making progress at a rate comparable to that of a matched group, such that the participant is given an advantage or “handicap” relative to the matched group to equalize chances of success relative to the matched group. The physical motivational incentive may be provided based on a performance metric of the participant, such as absolute change in body weight relative to an initial baseline measurement (after a period of time has elapsed from initiation of the regimen) or an unmet goal set by the participant and/or a facilitator.

In some alternative embodiments of the method 100, the method 100 may omit matched groups. For example, displaying feedback may include displaying the trend of a body metric measurement of a participant on the profile page of that participant, but not displaying a trend of the body metric measurement of any other participant or group of participants. By omitting matched groups, a facilitator may be assigned to work one-on-one with a participant, instead of in a group setting.

The FIGURES illustrate the architecture, functionality and operation of possible implementations of methods according to preferred embodiments, example configurations, and variations thereof. In this regard, each block in a flowchart or block diagram may represent a module, segment, portion of code, or method step, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

User Interface for Supporting a Health Regimen

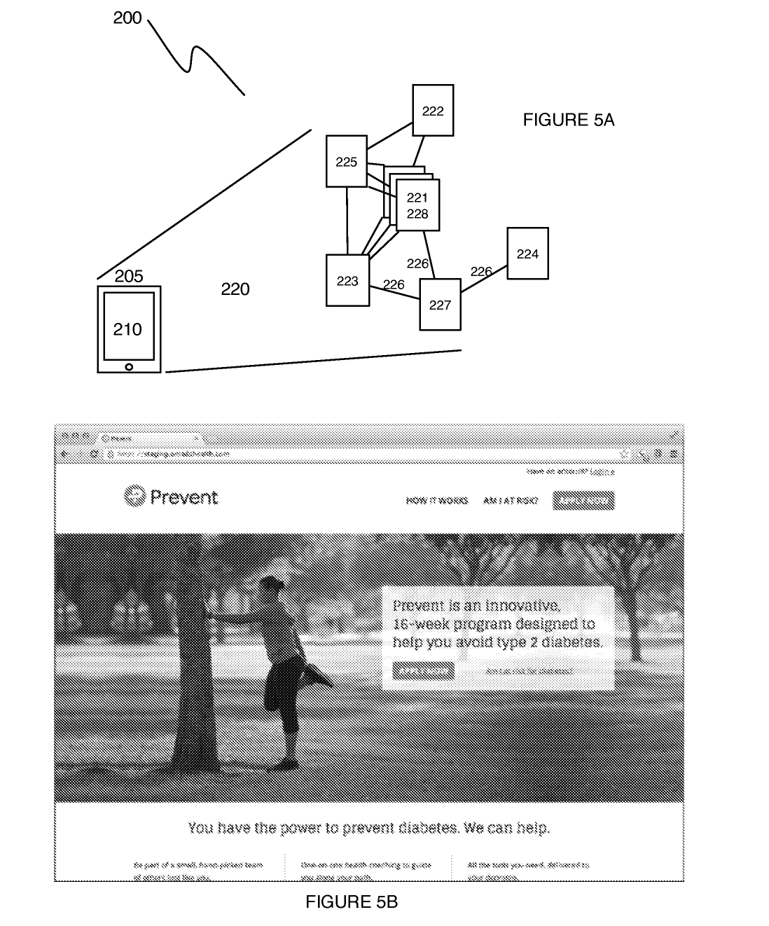

As shown in FIG. 5A, a user interface 200 for supporting a health regimen comprises a networked computing device 205 with a display 210, and an application 220 comprising a plurality of profile pages 221, each profile page corresponding to a respective participant in a first group participating in a health regimen, a progress page 222 accessible by a participant and configured to display health regimen progress of the participant, a first group page 223 corresponding to the first group ad a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228. The user interface 200 functions to render an interactive environment by which participants in a health regimen may receive peer-based support and facilitator-based support, as well as guidance (in the form of a health regimen curriculum) and/or personalized information regarding health regimen progress. As shown in FIG. 1, the user interface is preferably coupled to a system for supporting a health regimen.

The networked computing device 205 with a display 210 functions to process and render the application 220 for a participant. The networked computing device 205 with a display 210 is preferably a mobile device such as a smart phone, but can alternatively be a tablet, gaming device, laptop, desktop computer, television connected computing device, wearable computing device, or any suitable computing device configured to render and/or display an application. The networked computing device preferably includes an input device capable of detecting gestural input. Preferably, the input device is a touch screen, such that the display 210 also functions as a touch screen, but may alternatively be a cursor positioning device (e.g. a mouse or trackpad), a keyboard, a keypad, or any suitable input device.

The application 220 functions to provide an interface by which a participant and/or a facilitator may receive information regarding health regimen progress of a participant and/or a group of participants, and may interact with another participant in order to provide a source of motivation in support of a health regimen. In a first variation, the application 220 is centrally hosted by one or more servers, and interacts with a plurality of networked computing devices 205 with displays 210, each networked computing device 205 corresponding to a participant. In a second variation, the application 220 is hosted by a distributed system, wherein at least one networked computing device 205 with a display 210 functions as a participant terminal, as a local server, or as both. The application may be a web application accessible through a web browser on a networked computing device 205, or may alternatively be a native application on the networked computing device 205. The application 220 preferably comprises a plurality of profile pages 221, each profile page corresponding to a respective participant in a first group participating in a health regimen, a progress page 222 accessible by a participant and configured to display health regimen progress of the participant, a first group page 223 corresponding to the first group and a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228.

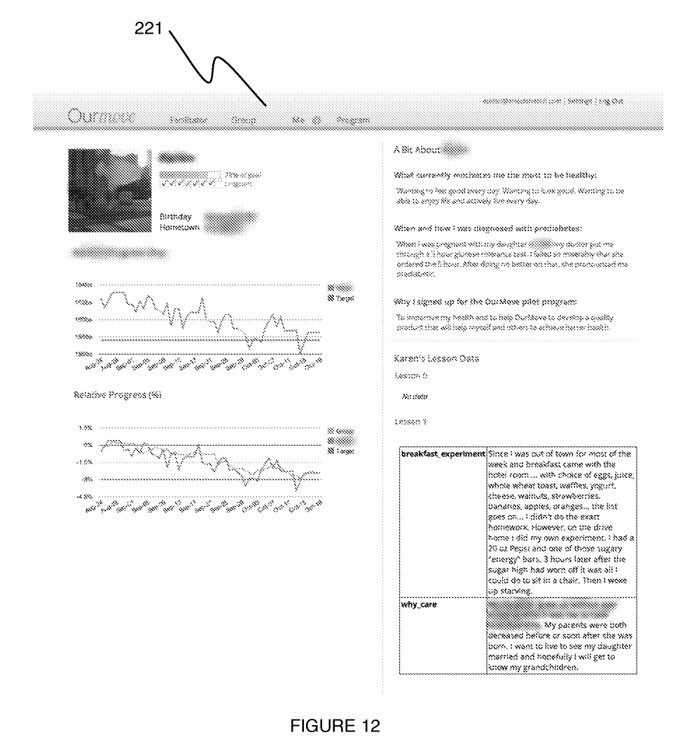

As shown in FIGS. 6 and 12, the plurality of profile pages 221 functions to display details of individual participant progress in a health regimen, as well as personal participant information. Each profile page in the plurality of profile pages 221 preferably displays annotated details of progress achieved by a given participant in the health regimen such as a trend in a body metric measurement of the participant, a trend in a body metric measurement of a participant relative to that of a matched group, and/or a target goal in the health regimen for the participant. Each profile page in the plurality of profile pages 221 may alternatively display non-annotated details of progress achieved by a given participant, or link to a progress page 222 configured to display non-annotated details of progress achieved by a given participant.

Each profile page is preferably configured to display biographical information submitted by the given participant, such as motivation for participating in the health regimen program and personalized goals. Each profile page may further be configured to display personal information such as a profile picture, name, summary of progress in the health regimen (e.g. percentage of health regimen program completed), birthday, age, geographical information, occupation, and/or any relevant personal information. Each profile page may enable the given participant corresponding to the profile page to enter additional information related to the health regimen but separate from the body metric measurements received from the measurement device, such as steps walked, meals eaten, answers to questions presented in the health regimen program, and/or any suitable information. Each profile page may also be configured to display images and/or links to profile pages corresponding to other participants in a matched group that comprises the given participant. Additionally, each profile page may comprise a messaging center configured to display messages between the given participant and a facilitator, and/or messages between the given participants and at least one participant of a matched group.

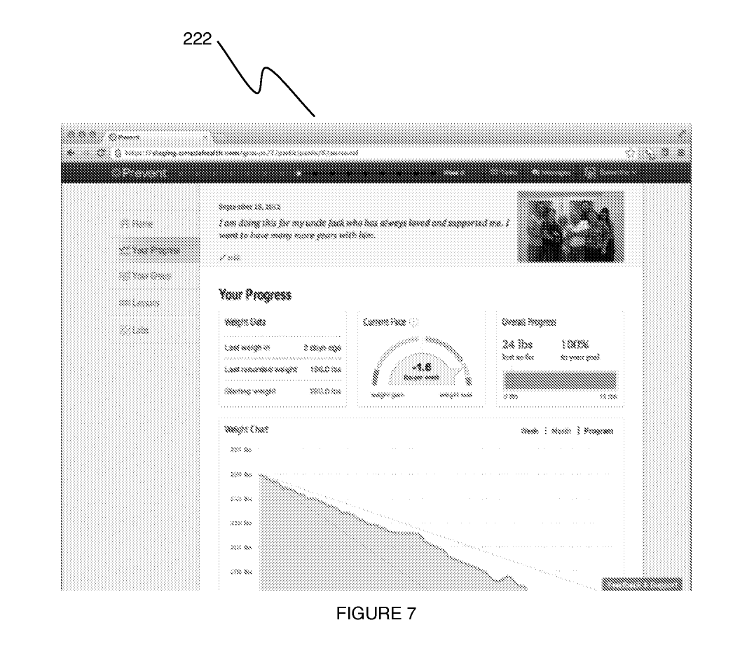

As shown in FIG. 7, the application 220 also comprises a progress page 222 accessible by a participant and configured to display health regimen progress of the participant. The progress page 222 functions to display participant progress in the form of visuals and/or analyzed metrics as a source of motivation for a participant following a health regimen. The progress page 222 is preferably configured to display details and analyses of progress achieved by a given participant in the health regimen such as a trend in a body metric measurement of the participant, a trend in a body metric measurement of a participant relative to that of a matched group, and/or a target goal in the health regimen for the participant. The progress page 222 may be further configured to display overall progress achieved by a participant relative to certain earlier points and/or a starting point, a rate of progress (e.g. body metric change versus time), overall progress achieved by a participant relative to a goal, and/or other personalized biometric data (e.g. current weight, height, age, body mass index). Preferably, the progress page 222 is distinct from a profile page for a participant; however, alternatively, the progress page 222 and profile page for a participant are non-distinct pages.

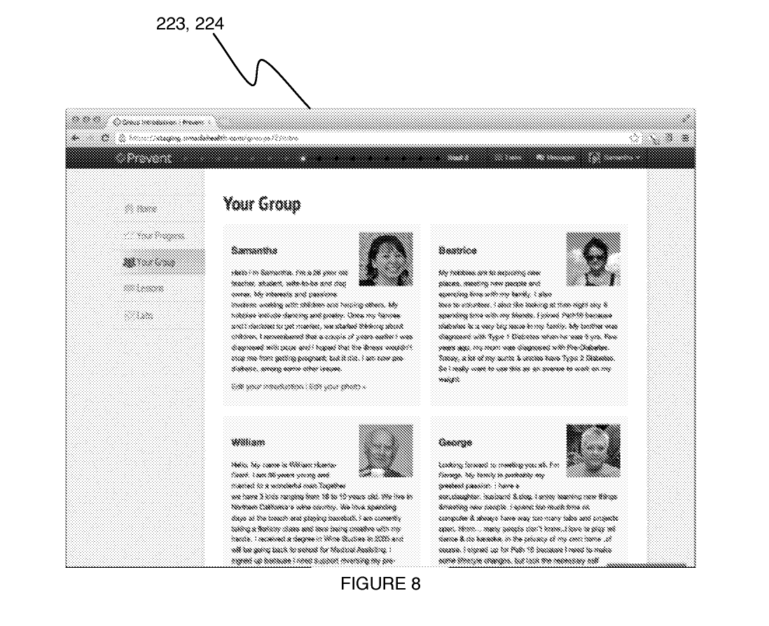

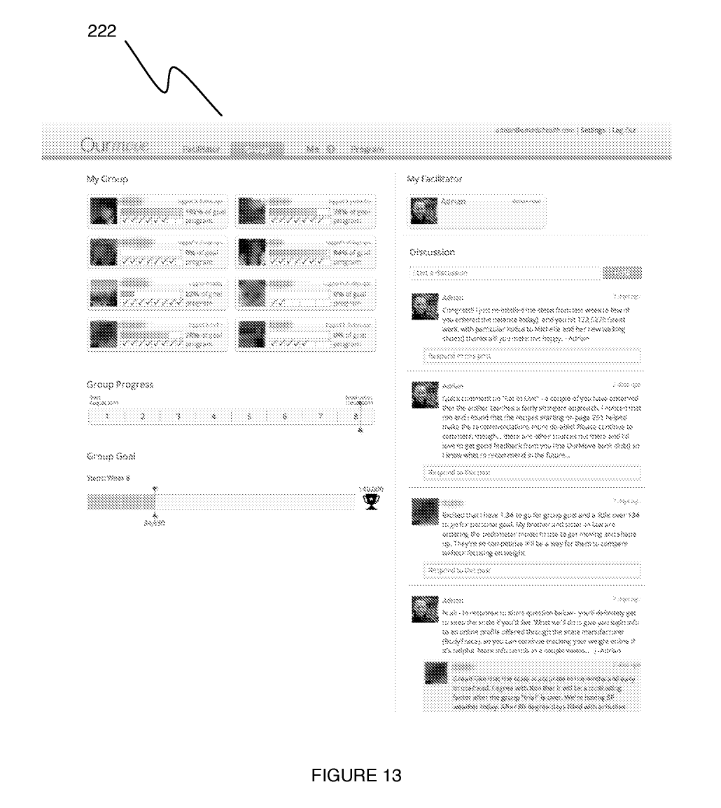

The application 220 also comprises a first group page 223 and a second group page 224 that each function to provide a centralized hub for interactions between participants of a group participating in a health regimen. As shown in FIGS. 8 and 13, a group page 223, 224 preferably displays a list and/or thumbnail summaries of the participants in a group participating in a health regimen, summary information about the progress of the group in the health regimen (e.g. trends and metrics determined from body metric measurement data), and any feedback addressed to the overall group from a facilitator and/or other participants. A group page 223, 224 preferably also comprises links to profile pages of all participants of the group, and may further comprise information regarding the health regimen being followed by participants in the group. In alternative embodiments, a group page 223, 224 may only display a list and/or thumbnail summaries of the participants in a group participating in a health regimen, and links profile pages corresponding to each member III the group participating in a health regimen, as shown in the example of FIG. 8.

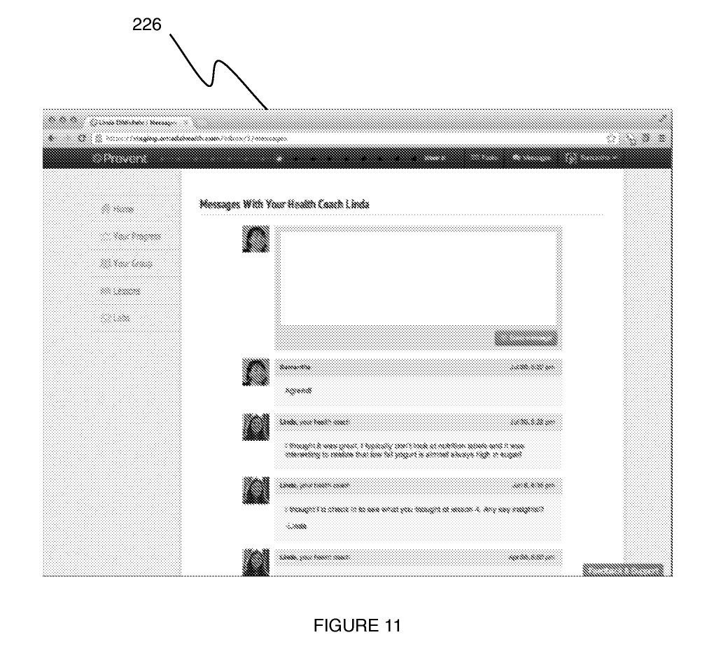

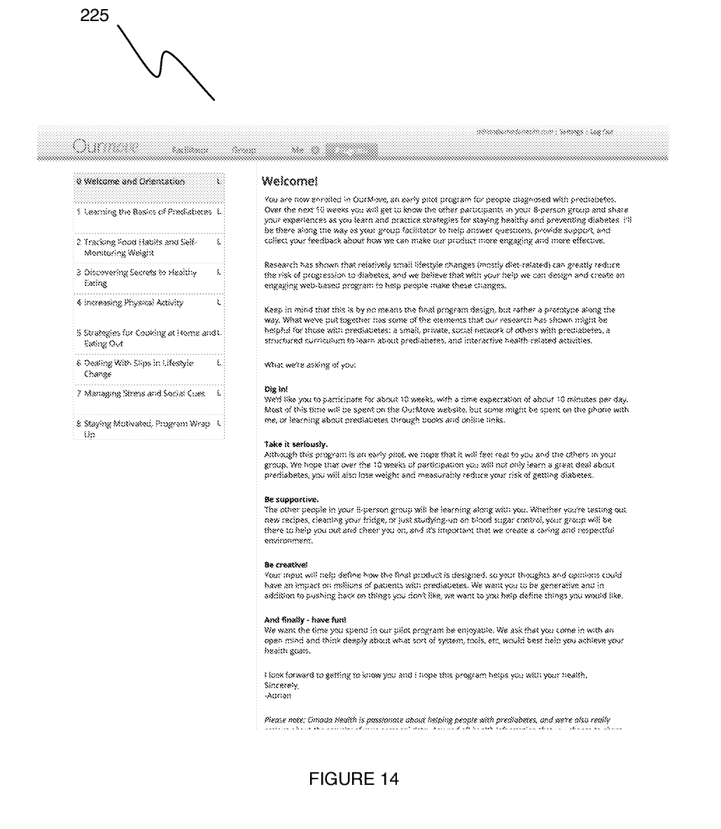

The application 220 also comprises a curriculum page 225 that functions to provide a health regimen curriculum intended to be followed by a participant. The curriculum page 225 preferably outlines steps or other features of a health regimen program. In the preferred embodiment, the curriculum page outlines steps based on the Diabetes Prevention Program (a research study funded by the National Institute of Diabetes and Digestive and Kidney Diseases), but in alternative embodiments, the curriculum page outlines steps or teaches lessons from other alternative health regimens. In an example, as shown in FIG. 14, the curriculum page 225 may include a welcome introduction to the program, tips, guidelines, and/or instructions corresponding to the health regimen program. In another example, as shown in FIG. 11, the curriculum page 225 may alternatively display health regimen tips in the form of a lesson plan, comprising modules, milestones, and/or assignments. Preferably, the curriculum page is configured to display the same curriculum for all participants in a group participating in a health regimen; however, alternatively, the curriculum page may be configured to display a curriculum that is customized to a given participant (e.g. based on participant performance). Preferably, the curriculum page 225 is accessible from a profile page 221, a progress page 222, and a group page 223, 224, but alternatively, the curriculum page 225 is accessible from a subset of a profile page 221, a progress page 222, and a group page 223, 224.

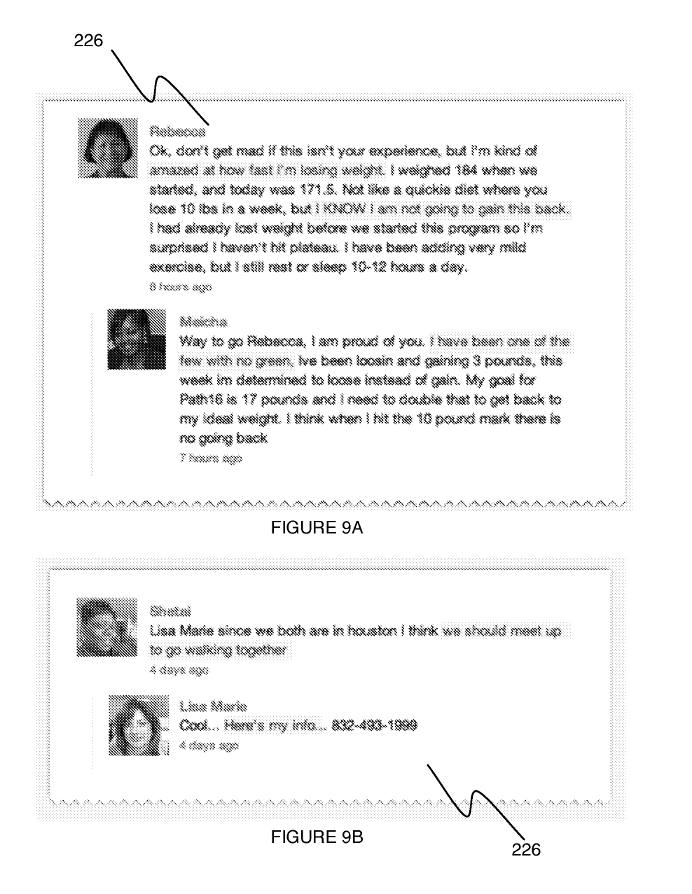

The application 220 also comprises a message client 226 that functions to enable communication between a participant and another entity, facilitated by the user interface. The message client preferably communicates with a server of a message service provider, server of a mailbox service that is a proxy for the message service provider, or any suitable messaging service. The message client preferably enables sending and receiving of messages, and may incorporate messages into a rendered interface. As shown in FIGS. 9A and 9B, the message client 226 may enable communication between a first participant and a second participant. In the example shown in FIG. 9A, a second participant may provide verbal motivational support to a first participant by describing a personal experience while following the health regimen. In the example shown in FIG. 9B, a first participant may connect with a second participant and set up a meeting to perform a task associated with a health regimen curriculum together. Additionally, the message client 226 may enable communication between a participant and a facilitator. In the example shown in FIG. 11, the facilitator may provide advice and motivational support to a participant through the message client 226, in a manner that is only accessible by the participant and the facilitator (i.e. no other participants have access to a communication between the participant and the facilitator). Preferably, either a participant or a facilitator may initiate a participant-facilitator communication by using the message client 226; however, alternatively, only the facilitator may initiate a participant-facilitator communication using the message client 226. The message client preferably also enables communication between more than two entities (e.g. a participant may communicate with at least two other participants, or at least one other participant and a facilitator).

The user interface preferably comprises at least two modes, including a facilitator mode 227 that is activated by a facilitator, and a participant mode 228 that is activated by a participant. The facilitator mode 227 and the participant mode 228 function to provide a facilitator view of the user interface and a participant view of the user interface that is preferably generally more restricted than the facilitator view (except, for example, a particular participant may have an unrestricted view of his or her own profile page), respectively. The facilitator and/or participant modes 227, 228 enable levels of privacy and/or access to respective profile pages of participants. In one example, in the facilitator mode 227 a facilitator of a group may have permission to view a trend in a body metric measurement represented both in percentage change and in absolute numbers, while in a participant mode 228 other participants of the group may be restricted to view only the trend in a body metric measurement represented in percentage change. In a second example, in the facilitator mode 227 a facilitator of a group may have access to all personal and/or biographic information corresponding to each participant in the group he or she facilitates, whereas in participant mode 228 a participant may only have access to his or her own personal and/or biographic information. Such restrictions are preferably set by the participant in a settings portal, as will be understood by one ordinarily skilled in the art. However, the user interface preferably enables each participant to set any suitable privacy and access settings to his profile page or other personal information.

In one embodiment, the facilitator mode 227 may further enable a facilitator to facilitate more than one group (e.g. the first and second group). The facilitator mode may thus comprise an additional facilitator page that enables the facilitator, using the message client 226, to communicate with all groups that the facilitator facilitates. The facilitator mode may enable the facilitator to communicate individually with members of the groups he/she facilitates, or to communicate with an entire group or portion of a group he/she facilitates. In a variation, the facilitator mode 227 may further enable a facilitator to have unrestricted viewing access to all profile pages and group pages corresponding to groups he/she facilitates, but may restrict the facilitator from modifying information displayed on the profile and group pages. In another variation, the facilitator mode 227 may enable a facilitator to have unrestricted viewing access to and the ability to modify all profile pages and group pages corresponding to groups he/she facilitates.

In other embodiments of the user interface 200, the first and second group pages 223, 224 may be further configured to provide a competition between the first group and the second group, in achieving a health regimen goal. In a first variation, a participant of the first group may compete with a portion of the participants of the second group, by accessing at least one of the first and second group pages 223, 224. In a second variation, the entire first group may compete with the entire second group, using at least one of the first and second group pages. Other embodiments of the user interface may incorporate additional pages, such as a home page, as shown in FIG. 5B, and/or functionality in the facilitator and participant modes 227, 228 to further support the health regimen.

System for Supporting a Health Regimen

A system 300 for supporting a health regimen comprises one or more body metric measurement devices 310 each corresponding to a participant, and configured to transmit a set of body metric measurement data; at least one server 320 configured to receive and store a set of body metric measurement data from the body metric measurement devices; a processor 330 configured to filter the set of body metric measurement data, thus producing a filtered set of body metric measurement data; an analysis engine 340 configured to analyze the filtered set of body metric measurement data and determine a trend in the filtered set of body metric measurement data; and a user interface 350 configured to provide health regimen progress information, a health regimen curriculum, and communication between the participant and a second participant. The system 300 may further comprise The system 300 preferably performs the steps as described in the method for supporting a health regimen and is supported by the user interface 200, which preferably helps foster a supportive community environment that motivates, inspires, and otherwise supports participants as they participate in the health regimen.

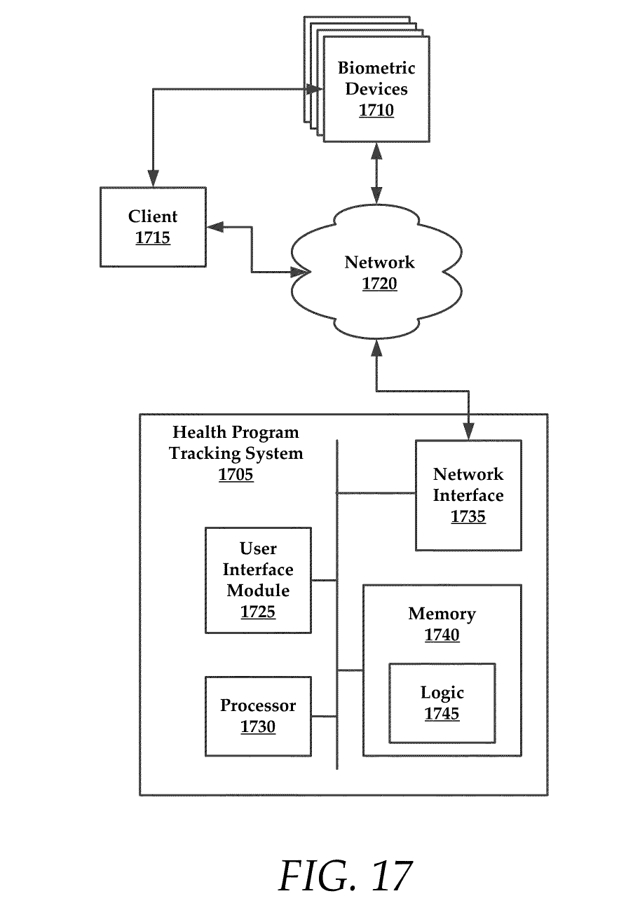

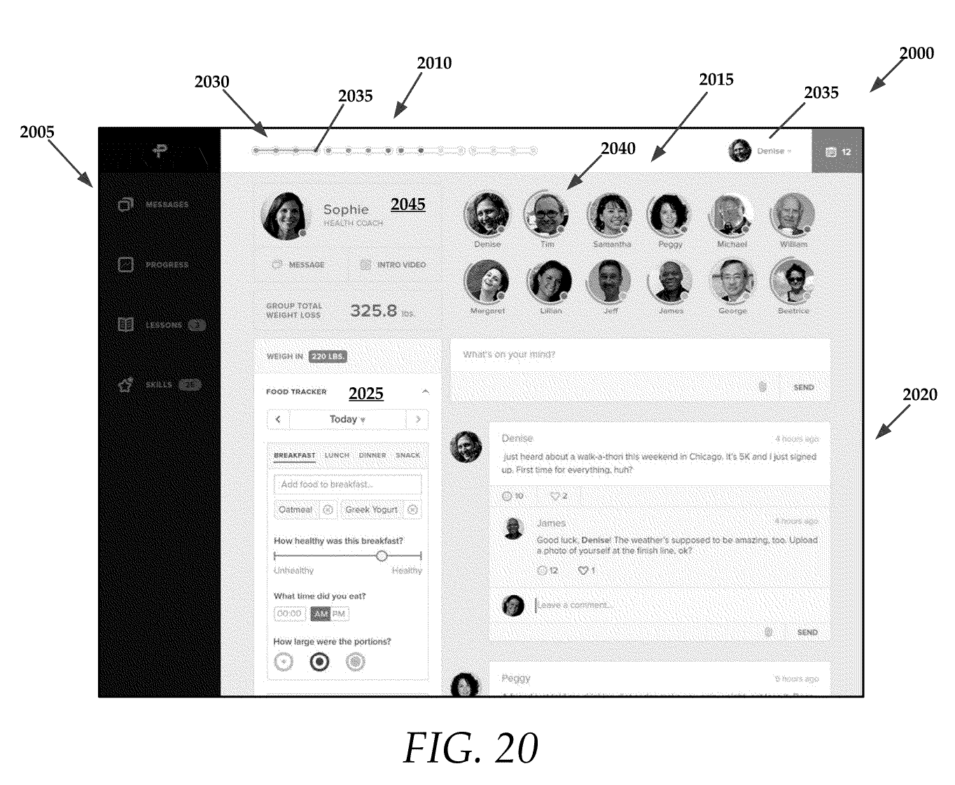

FIG. 17 illustrates an exemplary architecture for practicing aspects of the present technology. The architecture comprises a health program tracking system, hereinafter “system 1705” that is configured to track the performance of participants in a group program (e.g., a health regimen). Generally the system 1705 is configured to communicate with client devices, such as client 1715. The client 1715 may include, for example, a Smartphone, a laptop, a computer, or other similar computing device. An example of a computing device that can be utilized in accordance with the present invention is described in greater detail with respect to FIG. 20.

The system 1705 may communicatively couple with the client 1715 and biometric devices 1710 via a public or private network 1720. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1720 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

Suitable biometric devices include, but are not limited to, pedometers, scales, blood sugar monitors, blood pressure monitors, electrocardiograms (ECG), thermometers, heart rate monitors, and other medical or diagnostic devices that are configured to monitor or determine a wide variety of biometrics/biomarkers of an individual.

The system 1705 generally comprises a user interface module 1725, a processor, 1730, a network interface 1735, and a memory 1740. According to some embodiments, the memory 1740 comprises logic 1745 that can be executed by the processor 1730 to perform operations and methods such as the group program creation, participant matching, synchronous program initiation for participants in a group program, performance tracking, and other specified processes which are described in greater detail herein. More specifically, the system 1705 aids in improving one or more health conditions of participants in a group program in such a way that a maximum number of participants complete the group program and achieve a common health goal.

By way of example, a health condition may include obesity, pre-diabetes, heart disease, or other health conditions that would be known to one of ordinary skill in the art. Generally, a group program is a health improvement program that is tailored to the needs of the group. Examples of health improvement programs include, but are not limited to weight loss programs, diet programs, cardiovascular training, mental health programs, strength and conditioning programs, or other health improving endeavors. The health improvement program may include combinations of various programs.

A group program may take place according to an overall program time frame such as sixteen weeks or six months, just by way of example. The group program may be divided into a series of sub-programs. These series of sub-programs may have their own individual time frames, referred to as a sub-program time frame. Thus, while the group program may have a duration of, for example, six months, the group program may be divided into six separate sub-programs that are each a month in duration. In other instances, the group program may include a duration that can be divided into weeks, such as six weeks or sixteen weeks. The sub-programs and time frames can be of any granularity ranging from hour(s), day(s), week(s), month(s), quarter(s), year(s), and so forth.

It can be assumed that when a participant has achieved successful completion of the entire program, an improvement in the common health condition of the participant should be realized. For example, after successfully completing a six month period of prescribed diet and exercise the participant should realize an amount of weight loss and an improvement in certain biometric attributes that are indicative of deleterious health conditions such as diabetes, inflammation, heart disease, kidney function, and the like. Indeed, the health condition(s) that is improved is related to the details of the group program.

Advantageously, the group aspect of the health program provides psychological benefits to the participants in the group. Furthermore, a commonality in the health condition between the participants is also a supportive factor because the participants will be conducting the group program with other similarly health challenged individuals. Additionally, initiation of the group program is timed (synchronized) such that all participants begin a first of a series of sub-programs at the same time. Thus, none of the participants have an advantage over other participants and each are participating in the program on equal footing with regard to time.

According to some embodiments, the present technology may further enhance the cohesiveness and/or comradery of the participants in the group program, the system 1705 may be configured to match participants by common criteria such as a common health condition or a common geographical location, as well as other matching criteria described herein. Also, using a synchronous start time ensures that participants are performing the same tasks as one another and substantially at the same time. In addition to having a synchronized start time, the system 105 may encourage participants to achieve completion of tasks and sub-programs in a timely manner to ensure that the participants transition through the sub-program synchronously.

Using a common criteria such as geographical location also allows for a more level playing field, as participants are likely to experience the same climate and weather conditions. For example, participants in locations where the climate is warmer relative to other participants may be more likely to participate in extracurricular outdoor activities. Thus, these participants may have an advantage over their counterparts.

Other common criteria may include socio-economic status, education level, religious or political affiliation, or other criteria that would be known to one of ordinary skill in the art. In some embodiments, a group can be defined by a sub-type selected from any of an age range, a gender, a weight range, an education level, a religious affiliation, a political affiliation, a lifestyle affiliation, and any combination thereof.

In some embodiments the system 1705 may match candidates for the group program according to a common health condition, such as obesity, and a common geographical location, such as a city or state of residence.

In addition to the system 1705 initiating a group program in a synchronous manner, the system 1705 may be configured to establish a threshold that defines a number of participants that are required for the participant group. When a number of candidates meets or exceeds the threshold, the system 1705 may instantiate the group program.

For example, the system 1705 may set a threshold of twenty participants. When twenty participants that meet the group criteria specified in the system 105, the system 1705 may notify the candidates that the health program is about to be initiated. The system 1705 may issue the notice as an email, an SMS message, or other similar means for providing information to the individuals. The system 1705 may specify in the message the synchronous start date for the candidates that will comprise the participants in the group program. The system 1705 may initiate the group program by executing a first sub-program of the group program.

Regardless of the specific configurations of the group program, the goal of the system 1705 is to ensure that most, if not all, participants complete the group program and achieve the common health goal.

As mentioned above, the system 1705 may allow for the creation of sub-programs that comprise the group program. Further, the system 1705 may allow for the specification of individual tasks within a sub-program. That is, each sub-program may in turn be comprised of individual tasks. For example, a sub-program may include a task of “walking for one hour for each day in the week” and “eliminate sugary drinks and processed foods for the week” as well as “sleep eight hours per night during the week”.

Advantageously, the system 1705 can verify the completion of some of the tasks by receiving feedback from one or more biometric devices that are used by a participant. For example, the walking task described above can be verified by using a device such as a pedometer or a treadmill that is capable of outputting signals to the system 105 that are indicative of the activities of the participant.

In general, the system 1705 tracks the performance of each participant in the group program, and may monitor for the completion of individual tasks, the completion of sub-programs, and also the group program in its entirety. In addition to monitoring for completion of tasks and sub-programs, the system 1705 may track and monitor biometric attributes of the participants such as blood sugar levels, blood pressure readings, body mass index (BMI), weight, sleep cycles, and other similar biometric markers. Various biometrics may be obtained from devices that are capable of communicating with the system over the network 1720.

In addition to tracking metrics as described above, the system 1705 may be configured to generate various types of graphical user interfaces (GUIs) that allow the participants to interact with the system 1705 and participate in the group program. The various GUIs may be generated by the user interface module 1725. Examples of GUIs include login pages, where participants can be authenticated and logged into and out of the system 1705, as well as various GUIs that include task screens, program instructions, program guidelines, and performance metrics that are tracked by the system 1705. The nature of the content displayed on the GUIs may depend upon the type of group program being executed. For example, if the group program is a weight loss program intended to help individuals that are pre-diabetic, the system 1705 may specify various tasks related to helping the participants lose weight and improve certain biomarkers. To these ends, the system 1705 may display instructions such as nutritional goals, dietary guidelines, recipes, tips, or other informational content related to proper diet. Further, the system 1705 may provide a series of workout GUIs, organized as tasks. These GUIs may include workout instructional videos or tutorials. During the completion of these tasks, the system 1705 may provide GUIs that allow the user to record their accomplishments.

In some instances, the system 1705 may require third party verification, such as input from a personal trainer, nutrition coach, doctor, spouse, or other third party that can attest to the accomplishments of the participant.

By tracking the performance of the participants and objective, empirical data gathered from the various biometric devices or other biometric data sources, such as a medical report or a health record, the system 1705 can provide the participant with feedback or indicators that inform the participant as to their relative success or failure with respect to tasks, sub-programs, or the group program overall. In some instances, the participant may be required to periodically submit to one or more physical examinations, blood tests, a dual-energy x-ray absorptiometry (DEXA) scans or other similar types of diagnostics that are designed to reveal medical information.

According to some embodiments, once a participant in a group program has completed the group program by achieving success with respect to the common health goal, the system 1705 may indicate that the participant is eligible to participate in a sustaining phase of the group program. For example, if the participant may achieve a common health goal of losing a specified percentage of weight or reduce a certain biomarker into a medically healthy range of values, the system 1705 may transition the participant into a sustaining phase where the participant is allowed to continue using the system 105 to maintain their success with regard to the common health goal.

In some instances, the system 1705 may also utilize a synchronous start to the sustaining phase, which is similar to the synchronous start for the group program. That is, the system 1705 may require that a threshold number of successful participants from the group program to be ready to start the sustaining phase before the system 1705 allows the participant to initiate the sustaining phase.

In other embodiments, the system 1705 may migrate a participant to the sustaining phase immediately upon successful completion of the group program. The system 1705 may track various metrics regarding a common health condition that the participant is attempting to sustain. For example, the system 1705 may determine if the weight of the participant remains within a range of acceptable values. If the participant is unsuccessful in the sustaining phase, the system 1705 may detect this failure by evaluating the metrics gathered about the participant. For example, the system 1705 may determine that the participant has gained more weight than allowed during the sustaining phase. Rather than relying on the participant to acknowledge or detect their failure to sustain their weight loss and voluntarily remediate their weight gain, the system 1705 may automatically revert the participant back to the group program. The ability of the system 1705 to automatically transition the participant back to the group program is advantageous because the participant may not be aware that their health condition is impaired. For example, if the common health goal is to keep a certain biomarker within a range of acceptable values, the system 1705 may determine that the biomarkers of the participant are outside the range of acceptable values. Prompt identification of failure and quick remediation may allow the participant to return to the sustaining phase.

The system 1705 may attempt to place the participant into a second group program in such a way that the participant is matched with other participants that have the same health condition and geographical location, if possible. Further, the system 1705 may place the participant in a group program that is currently being executed. The system 1705 may attempt to “synchronize” the participant into the second group program based upon the degree of failure realized during the sustaining phase. For example, the system 1705 may determine that the participant has gained 15 pounds during the sustaining phase. The system 1705 may place the participant into a second group program where the participants are all within 15 pounds of successfully completing the group program.

Because the system 1705 tracks the relative success and failure of the participants with respect to the tasks assigned to the participants, the system 1705 may identify problematic tasks or weaknesses of the participants. For example, the system 1705 may determine that a participant frequently fails to achieve success around nutritional goals, but that the user is frequently successful at their activity goals. The system 1705 may issue notifications or messages to the participant that informs the participant of these weaknesses. The system 1705 may also determine that supplemental guidance or modification of a task may be appropriate to help the participant to achieve the goal in a different manner. For example, the system 1705 may determine that a participant fails to workout a prescribed four times per week, but that the participant always works out at least three times per week. As an alternative the system 1705 may suggest that the participant work out an extra fifteen minutes per workout session, or add an hour long walk into their schedule for the week.

In some instances, the system 1705 may execute the user interface module 1725 to generate GUIs that include performance metrics for a participant. In other instances, the GUIs may include performance metrics for other participants, which are displayed to a particular participant, which allow the participant to view the performance of other participants in the group program. Allowing one participant to view the performance metrics of other participants in their group may foster a competitive spirit and aid in improving the performance of the participants. The system 1705 may provide competitive performance metrics when the system 105 determines that a participant is failing to complete tasks or meet benchmark performance requirements for a sub-program. In some instances, the performance metrics may relate to a specific task, such as “run a mile in under twenty minutes”. Using metrics determined from an exercise tracking biometric device, such as a watch that records run time and distance, the system 1705 may determine that one participant is underperforming relative to the established goal. They system 1705 may output a message or GUI to the participant that others in the group program have successfully completed the goal. The message may also include running tips or a questionnaire that includes questions that are designed to elicit responses that aid the system 1705 in determining why the participant is unable to meet their goals.

More broadly, when the system 1705 determines that a participant has failed to meet a goal, the system 1705 may use a question or survey process to elicit information that allows the system 1705 to suggest program modifications or task modifications that allow the participant to achieve the desired goals. Further, if the goal is unattainable for one or more reasons, the system 1705 may substitute a goal that can be achieved by the participant. For example, if the system 1705 elicits a response from a participant that indicates that the participant cannot complete a running goal because the participant has sustained a knee injury, the system 1705 may suggest an alternative goal such as “swim for thirty minutes”. In some instances, the substituted task/goal that is suggested preferably is equivalent to the original task/goal with respect to the overall program. Thus, if the original task/goal was to “run a mile” to burn a set number of calories, the system 1705 may suggest “swim for an hour” to burn the same number of calories.

With respect to displaying metrics, the system 1705 may generate various icons or visual representations of successful completion or failure to successfully complete a task or sub-program. For example, the system 1705 may display a check mark next to a completed goal. Alternatively the system 1705 may display a red exclamation point next to a task that was not completed successfully. Tasks where a participant is in danger of failing may be displayed using an icon that indicates that the participant needs to pay closer attention to the task.

According to some embodiments, the system 1705 may be configured to display metrics of participants in a group program tailored to achieving a common health goal. The system 1705 may be configured to track performance of participants in a group program. Various methodologies described above for tracking performance may include the monitoring of biometric devices, receiving feedback from medical personnel or electronic medical related records. Also, in some instances, the participants may input their participation related information into the system 1705 using a mobile device or other computing system. The participation related information may be specific to various tasks assigned to the program participants. For example, if a task is “workout with a personal trainer at least three times per week”, the participant may identify dates where they worked out with their trainer. The system 1705 may receive verifying information from the trainer or other individual that has knowledge of the participant's attendance.

Again, it is noteworthy that the group program includes an overall program time frame and that the group program includes one or more (and often a plurality) of sub-programs that when executed by the participants in the participant group aid the participants in achieving the common heath goal.

Each of the sub-programs comprises a task (or tasks) that are to be completed by the participant. Thus, hierarchically, tasks are aggregated into sub-programs and sub-programs are aggregated into the group program. As mentioned above, these programs may utilize the synchronous start principles described above.

The details of the tasks and grouping of these tasks into sub-programs, as well as the order of execution of the sub-programs may be tailored by the system 1705 in response to the common health goal that is to be achieved. For example, if the common health goal is weight loss, the system 1705 may establish tasks that are designed to promote weight loss. The ordering and grouping of these tasks are done so as to maximize the efficiency with which participants can achieve the common health goal of weight loss. Thus, the overall program time frame may also be considered by the system 1705 in designing and setting tasks and sub-program configurations.

In some instances, the system 1705 may consult prior group program outcomes or histories in determining which tasks and groupings of tasks are most advantageous for the participants, in view of the common health goal. Thus, if the participants are all within the same age range or fitness level, such as “moderately fit”, the system 1705 may select different sets of tasks compared to participants that are less fit or in poorer health.

During participation in the group program, such as during or after the execution of particular tasks, the system 1705 monitors or tracks the participation of group program participants as mentioned above. After receiving or collecting such data, the system 1705 may generate, for each participant in the group program, a first visual display that represents a current completion percentage for at least one of a sub-program and the group program. In some embodiments, the current completion percentage may be calculated from a completion percentage of each of the one or more sub-programs.

In accordance with the present disclosure, the system 1705 may generate and provide a graphical user interface (GUI) that includes a first visual display for a first participant that is indicative of the current completion percentage for the task of a sub-program. FIG. 20 illustrates an exemplary GUI 2000 that includes the first visual display for a first participant that is indicative of the current completion percentage for the task of a sub-program. The GUI 2000 includes a dashboard that generally includes a navigation ribbon or pane 2005, a program progress indicator 2010, a plurality of visual displays 2015 for various participants in a group program, a newsfeed 2020, and a data input interface frame 2025. The data input frame 2025 may provide the participant with various input mechanisms that allow the participant to log task or program related information into the system. For example, the participant may utilize the data input interface frame 2025 to input food consumed, food ratings, meal time frames, exercise information, and so forth.

In some embodiments, the navigation pane 2005 may include one or more selectable menu options, such as messages (e.g., private messaging system), progress, lessons, and skills. Each of these menu options may be selected by a participant and function to launch their associated features or modules. For example, clicking on the lessons option may launch a lessons list that includes instructional information associated with a current portion of the program that is active for the participant. The navigation pane 2005 may be populated with a wide variety of options.

The progress indicator 2010 may include a plurality of individual sub-program bars 2030, which each include a dot 2035. Each dot within a bar may represent a task or portion of a sub-program for the group program. In this instance, each sub-program includes four tasks, represented as dots. The overall program is shown has having four sub-programs. It will be understood that a sub-program may have more or fewer tasks, and a group program may have more or fewer sub-programs.

The dots that are filled in represent tasks that have been completed, whereas empty dots are representative of uncompleted tasks. Thus, dots will be filled linearly from left to right as tasks are completed. While the progress indicator 2010 has been illustrated and described as comprising linearly arranged groupings of dots, the progress indicator may include many other aesthetic representations and arrangements or such representations that would be known to one of ordinary skill in the art.

The newsfeed 2020 may include a mechanism that allows for participants in the group to communicate with one another. Posts or news generated by participants may show up in the newsfeed of each of the participants.

A first visual representation 2035 for a participant, which in this case is “Denise”, includes a circular photograph of the participant. Encircling the photograph is a circular indicator that is at least partially filled in accordance with an amount of the group program that has been accomplished by the participant. For example, if the participant has a current completion percentage of 50% for a task, the circular indicator may encircle only 50% of the photograph of the participant. An example of a circular indicator is better illustrated with reference to a larger visual indicator 2040 for another group participant (e.g., “Tim”). It will be understood that visual indicators for other participants are shown in the GUI 2000 for “Denise”.

According to some embodiments, the system 1705 may also generate a second visual display that represents a current completion percentage of the group program. Thus, the system 1705 may display a second visual display that illustrates whether or not the participant has completed one or more previous sub-programs, and the first visual display illustrates a percentage of completion of a task for the participant. Thus, the first visual display is both more granular and current with regard to tracked information that is displayed compared to the second visual display that only illustrates previous completed sub-programs. Stated otherwise, the display of information related to a current completion of a task is more indicative of current participation as opposed to displaying information for previously completed sub-programs, which may be shown as “completed” when all tasks for that sub-program are complete. The progress indicator 2010 is an example of a secondary visual display or indicator.

In some embodiments, the GUI generated by the system 1705 includes not only first and second visual displays for a first participant, but also first and second visual displays (GUIs) for other participants in the group program. In other words, a group participant may be shown or illustrated other visual displays that are related to additional group participants. Thus, each participant can visually apprehend not only their performance information but also the performance information of other participants, which may work to foster competition amongst the participants. For example, the visual indicator 2040 for participant “Tim” can be shown on a GUI 2000 generated for participant “Denise”.

In some instances, the system 1705 may identify the first participant to complete a particular task or tasks. The system 1705 may rank or order the display of the participants in order of current completion for a task.

According to some embodiments, the system 1705 may generate a first visual display that comprises a progress indicator that is filled in accordance with the current completion percentage for a task. For example, the progress indicator may include a bar or circle diagram that are provided with a coloring, shading, or highlighting to indicate current completion value. The first visual indicator 2035 comprising the circular ring may be filled in accordance with a completion percentage of a task or a sub-program completion percentage. Thus, as the task or sub-program is completed, the visual indicator progressively encircles the photograph of the participant.

The progress indicator may also include numerical percentage indicia that represents the current completion value or the percentage of the task that is yet to be completed. For example, a circular visual display may show a percentage of the circle colored with a first hue, which indicates the current task completion value, whereas the remainder of the circle is colored with a second hue and represents the percentage of the task that is yet to be completed. The visual display may also include an estimated completion date or time for the task that can be calculated by the system 1705. One of ordinary skill in the art will appreciate that other visual indicators can be used in accordance with the present technology.

In some embodiments, the system 1705 may be configured to reset the second visual display when a new sub-program is initiated by the participant. This may include clearing of indicator colors or other indicia used to represent the completion of a sub-program.

Also, the system 1705 may be configured to identify non-responsive participants by comparing completion percentages associated with tasks to threshold values. The threshold values include expected completion percentages for the tasks at various reference points. These reference points may be defined by the system 1705. For example, the system 1705 may set a threshold for 75% completion of a task that is required from within three days of the participant initiating the task. That is, within three days of starting a task, the system 1705 will determine if the participant has completed at least 75% of the task. If not, the system 1705 may identify the participant as non-compliant.

In another example, if a set of participants in the group program have a current completion value of 75% for a task and one participant has a current completion value of 25%, the system 1705 may identify that participant as being non-responsive, and may flag the participant for intervention by a coach or other medical professional.

In some embodiments, the system 1705 may provide the first and second visual displays to a coach or other third party that has been tasked with also monitoring or facilitating the group program. It will be understood that the coach is not a participant in the group program but oversees the performance of the participants during the group program and provides guidance to the participants to help the participants in achieving the common heath goal. An example of a coach may include a personal trainer, a dietician, a physician, a nurse, a nurse practitioner, or other similar individual.

In some embodiments, the coach or third party may utilize the system to 1705 provide a modification to a sub-program when a participant is underachieving in the sub-program or a task associated with the sub-program. That is, the system 1705 may inform the coach that a participant is underachieving at a task by transmitting to the coach an alert message, such as an SMS message, an email, a telephonic message, or other similar notifications.

The GUI 2000 may include a coach pane 2045 that provides a means for allowing the participant to interact with a coach. For example, the coach pane 2045 may include a messaging feature as well as an instructional or introduction message, such as a video. The coach may leave messages for the participant that may appear in the coach pane 2045.

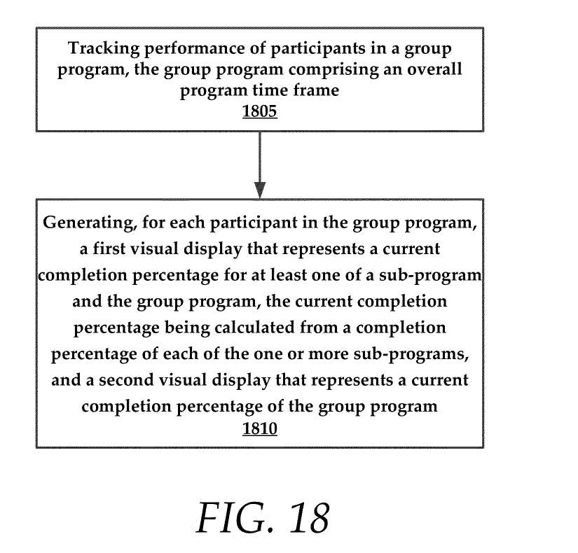

FIG. 18 is a flowchart of an exemplary method for displaying metrics of participants in a group program tailored to achieving a common health goal using a health program tracking system. The method in some embodiments comprises tracking 1805 performance of participants in a group program. As mentioned above, the group program includes an overall program time frame as well as one or more sub-programs that when executed by the participants in the participant group aid the participants in achieving the common heath goal. According to some embodiments, each of the sub-programs comprising a task to be completed by the participant.

In some instances, the method includes generating 1810, for each participant in the group program, a first visual display that represents a current completion percentage for at least one of a sub-program and the group program. It is noteworthy that the current completion percentage is calculated from a completion percentage of each of the one or more sub-programs. The step of generating also includes generating a second visual display that represents a current completion percentage of the group program.

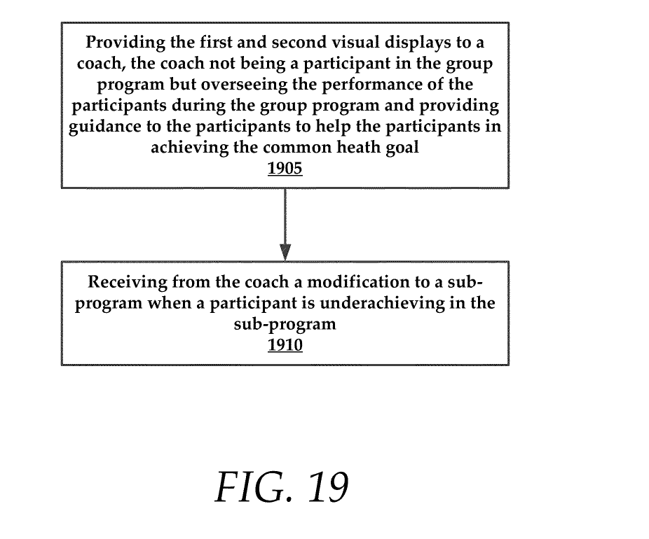

FIG. 19 a flowchart of an exemplary method for displaying performance related metrics to a coach or third party. Initially, the method includes providing 1905 the first and second visual displays to a coach. Again, the coach is not a participant in the group program but oversees the performance of the participants during the group program and provides guidance to the participants to help the participants in achieving the common heath goal. In some embodiments, the method includes 1910 receiving from the coach a modification to a sub-program when a participant is underachieving in the sub-program. As mentioned above, the coach may post messages to the participant using the coach pane 2045. In some instances, the coach may modify a task or sub-program for a participant. The changes to the program will be reflected in the GUI 2000 where appropriate.

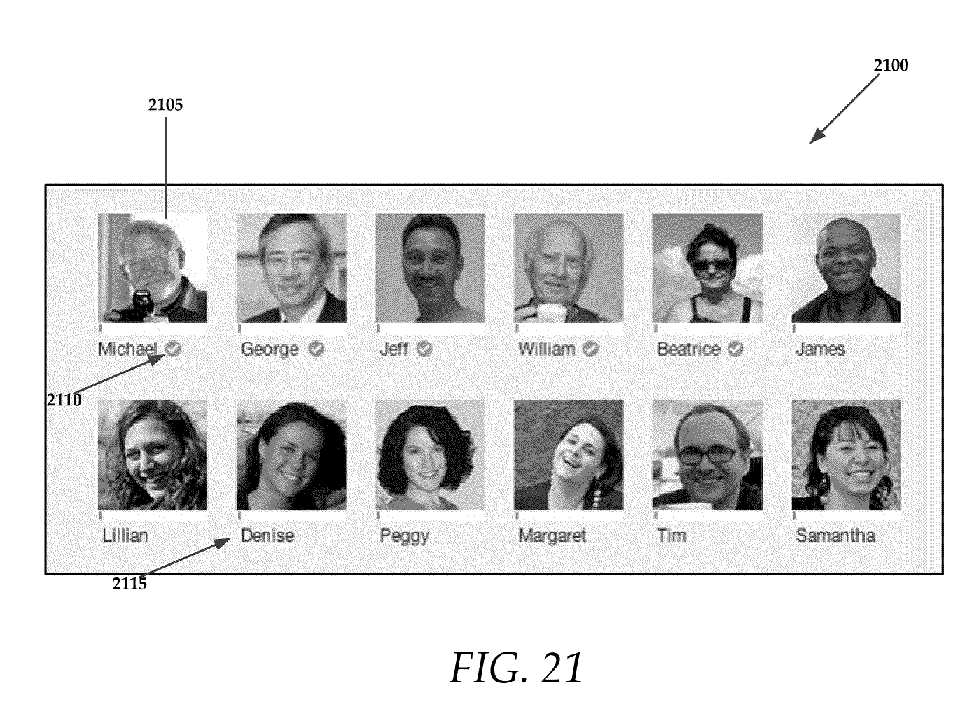

FIG. 21 illustrates a GUI 2100 that illustrates visual indicators that illustrate when a participant has successfully completed a task. For example, participant “Michael” 2105 has successfully completed a task (along with several other participants). When the task is complete, a check mark 2110 is placed proximate the visual indicator 2105 for the participant. In contrast, other participants, such as “Denise” 2115, who have yet to complete the task do not have a check mark. GUI 2100 may provide a quick visual reference for a coach to see which participants have completed a given task, or a sub-program. The GUI 2100 may also be integrated within the GUI 2000 of FIG. 20.

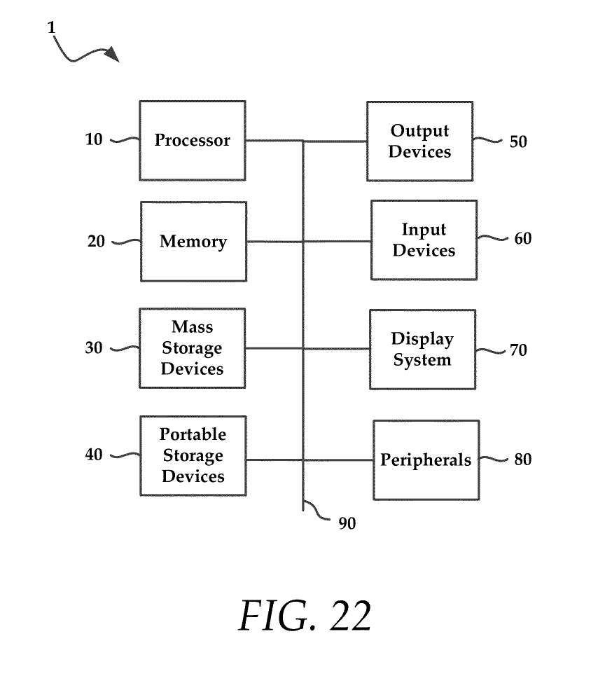

FIG. 22 illustrates an exemplary computing device 1 that may be used to implement an embodiment of the present systems and methods. The system 1 of FIG. 22 may be implemented in the contexts of the likes of clients, information display systems, computing devices, terminals, networks, servers, or combinations thereof. The computing device 1 of FIG. 22 includes a processor 10 and main memory 20. Main memory 20 stores, in part, instructions and data for execution by processor 10. Main memory 20 may store the executable code when in operation. The system 1 of FIG. 22 further includes a mass storage device 30, portable storage device 40, output devices 50, user input devices 60, a display system 70, and peripherals 80.

The components shown in FIG. 22 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 22. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 22 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device. Peripherals 80 may include any type of computer support device to add additional functionality to the computing system. Peripherals 80 may include a modem or a router.

The components contained in the computing system 1 of FIG. 22 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for displaying metrics of participants in a group program tailored to achieving a common health goal using a health program tracking system comprising a processor and logic, the logic being executed by the processor to perform the method, comprising:
tracking performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and
generating, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program.

2. The method according to claim 1, further comprising providing a graphical user interface comprising the first and second visual displays for a first participant.

3. The method according to claim 2, wherein the graphical user interface includes first and second visual displays for other participants in the group program, the visual displays being provided to the first participant.

4. The method according to claim 1, further comprising providing the first and second visual displays to a coach, the coach not being a participant in the group program but overseeing the performance of the participants during the group program and providing guidance to the participants to help the participants in achieving the common heath goal.

5. The method according to claim 4, further comprising receiving from the coach a modification to a sub-program when a participant is underachieving in the sub-program.

6. The method according to claim 1, wherein the participants have been matched into the participant group based upon a common health condition and a common geographical location.

7. The method according to claim 1, wherein tracking performance includes receiving biometric data of a participant from a biometric data measurement device that is coupled with the health program tracking system.

8. The method according to claim 1, wherein a sub-program comprises a series of tasks that are to be accomplished by the participants.

9. The method according to claim 1, wherein the first visual display comprises a progress indicator that is filled in accordance with the current completion percentage for the task.

10. The method according to claim 1, further comprising resetting the second visual display when a new sub-program is initiated by the participant.

11. A system for displaying metrics of participants in a group program tailored to achieving a common health goal, the system comprising:
a processor; and
a memory for storing logic, the logic being executed by the processor to:
track performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and
generate, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program.

12. The system according to claim 11, wherein the processor further executes the logic to provide a graphical user interface as the first visual display for a first participant that is indicative of the current completion percentage for the task of a sub-program.

13. The system according to claim 12, wherein the graphical user interface includes first and second visual displays for other participants in the group program, the first and second visual displays being provided to the first participant.

14. The system according to claim 11, wherein the processor further executes the logic to provide the first and second visual displays to a coach, the coach not being a participant in the group program but overseeing the performance of the participants during the group program and providing guidance to the participants to help the participants in achieving the common heath goal.

15. The system according to claim 14, wherein the processor further executes the logic to receive from the coach a modification to a sub-program when a participant is underachieving in the sub-program or a task associated with the sub-program.

16. The system according to claim 11, wherein the participants have been matched into the participant group based upon a common health condition and a common geographical location.

17. The system according to claim 11, wherein the system tracks performance by receiving biometric data of a participant from a biometric data measurement device that is coupled with the system.

18. The system according to claim 11, wherein the first visual display comprises a progress indicator that is filled in accordance with the current completion percentage for a task.

19. The system according to claim 11, wherein the processor further executes the logic to reset the second visual display when a new sub-program is initiated by the participant.

20. The system according to claim 11, wherein the processor further executes the logic to identify non-responsive participants by comparing completion percentages associated tasks to threshold values, wherein the threshold values include expected completion percentages for the tasks at various reference points.

21. A method for displaying metrics of participants in a group program tailored to achieving a common health goal using a health program tracking system comprising a processor and logic, the logic being executed by the processor to perform the method, comprising:
tracking performance of participants in a group program, the group program comprising an overall program time frame, the group program comprising one or more sub-programs that when executed by the participants in the participant group aid the participants in achieving the common heath goal, each of the sub-programs comprising a task to be completed by the participant; and
generating, for each participant in the group program, a first visual display that represents a current completion percentage for at least one of a sub-program and the group program, the current completion percentage being calculated from a completion percentage of each of the one or more sub-programs, and a second visual display that represents a current completion percentage of the group program, wherein the first visual display includes a circular bar that encircles a photograph of a participant, and the circular bar encircles the photograph in accordance with the completion percentage, further wherein the second visual display comprises linear arrangement of dots representing previously completed tasks of the at least one sub-group, the dots being filled after completion of the tasks associated therewith.
